(19) United States
(12) Patent Application Publication
(10) Pub. No.: US 2006/0076498 A1
(43) Pub. Date: Apr. 13, 2006

(54) X-ray detector device and method for producing an X-ray detector device

(76) Inventors: Thomas Hilderscheid, Altdorf (DE); Thomas Von Der Haar, Nuernberg (DE)

Correspondence Address: HARNESS, DICKEY & PIERCE, P.L.C., P.O.BOX 8910, RESTON, VA, 20195, US

(21) Appl. No.: 11/247,255

(22) Filed: Oct. 12, 2005

(30) Foreign Application Priority Data
Oct. 13, 2004 (DE) 10 2004 049 917.9

(51) Int. Cl. G01T 1/24

(52) U.S. Cl. 250/370.09

(57) ABSTRACT

To permit straightforward assembly of an X-ray detector including matricially arranged detector modules, detector modules are initially combined to form a bar. A plurality of the bars are subsequently fastened next to one another on a detector support mechanism to form the X-ray detector.

The present application hereby claims priority under 35 U.S.C. §119 on German patent application number DE 10 2004 049 917.9 filed Oct. 13, 2004, the entire contents of which is hereby incorporated herein by reference.

### FIELD

The present invention generally relates to an X-ray detector device. For example, it generally relates to one having a collimator and a multiplicity of matricially arranged detector elements, which are aligned in rows and columns with the aid of the collimator. The invention also generally relates to a method for producing such an X-ray detector device.

### BACKGROUND

An X-ray detector device is disclosed, for example, by DE 202 20 461 U1. It is used particularly for imaging methods in the medical field. Flat solid-state detectors are being used increasingly in medical diagnosis. These detectors include an X-ray converter, which converts the X-rays striking it either directly into electrical charges or into photons, which are registered by electrodes or photodiodes and evaluated.

So-called modules are used as detector elements in order to design detectors with surfaces that are as large as possible, and these modules are in turn constructed from a multiplicity of matricially arranged individual detector pixels, with each individual pixel delivering one image point. Such X-ray modules are described, for example, in DE 103 07 752 A1 or in DE 101 16 222 A1.

The detector modules are fastened on a detector support mechanism in order to form the flat detector. The installed detector modules in this case usually form a subsection of a curved lateral cylinder surface, which defines the detector surface.

In order to generate images with the best possible quality for the image generation in medical imaging methods when exposing an object, i.e. a patient, it is necessary to eliminate scattered radiation which occurs and to only evaluate the primary rays for the image generation. The solid-state detector and the individual detector modules are therefore preceded by so-called scattered radiation grids or collimators. These are essentially formed by shafts oriented mutually plane-parallel and in the direction toward the focus of the X-ray source, their sidewalls having a very high X-ray absorption. Owing to the finite width of these plate-like sidewalls and their arrangement in front of the flat detector, certain dead regions are formed where no X-radiation strikes the flat detector.

Insensitive intermediate regions, which are arranged below the dead zones or shadow regions, are provided on the flat detector in order to avoid image artifacts due to these dead zones. These intermediate regions must necessarily be aligned with the individual dead regions due to the collimator.

In the event of deficient alignment, for example, such a dead region would be partially arranged in front of an X-ray sensitive area of the detector. The effect of this, however, would be that the shadows cast by the collimator move over the sensitive area in the event of a slight movement (wobble) of the X-ray source and the resulting different radiation direction. Merely the “wobbling” of the X-ray source would therefore cause an intensity fluctuation to be registered, which would lead to a false image evaluation. A highly precise arrangement of the individual detector modules is therefore indispensable. This highly precise alignment, however, becomes increasingly difficult as the size of the flat detectors increases.

### SUMMARY

An object of at least one embodiment of the invention is to provide an X-ray detector device and/or method for its production, with which highly accurate alignment of the individual detector elements can be achieved in a straightforward way.

An object may be achieved according to at least one embodiment of the invention by an X-ray detector device having a collimator and a multiplicity of matricially arranged detector elements, which are aligned in rows and columns with the aid of the collimator. The detector elements of a column in this case form a bar and are fixed and aligned on a common support element. The individual bars are in turn fastened on a detector support mechanism.

This configuration therefore involves a two-stage process for achieving highly accurate alignment. Specifically, the detector elements of a column are initially aligned in a row and combined on the support element in order to form a bar. In the second step, the individual bars are then aligned and fastened on the detector support mechanism.

It is therefore no longer necessary to fasten each individual detector module directly on the detector support mechanism. This is helpful because, particularly in the case of a detector with a large area and a matricial arrangement of detector modules, it is very difficult to accurately align the detectors arranged in the middle, in particular, and fasten them with respect to the detector support mechanism.

Owing to the combination of the detector elements to form a bar, the problem of highly accurate alignment may therefore be offset into a prefabrication stage in which the alignment and fastening are preferably carried out with a special adjusting device. Because the detector elements arranged in a row are combined to form a bar, they can be aligned together in a comparatively straightforward way on the detector support mechanism.

According to an example expedient configuration of at least one embodiment, the detector elements are in this case adhesively bonded on the support element. It is alternatively possible for holding elements or stop elements, on which the individual detector elements are aligned and fastened, to be fastened on the support element.

With a view to exact alignment of the collimator with respect to the individual detector elements, in an expedient configuration, a respective bar is connected to a collimator element and fastened together with it on the detector support mechanism. The collimator element and the bar with the plurality of detector elements arranged in a row therefore form a structural unit. The collimator element is already aligned relative to the detector elements before fastening in the detector support mechanism.

In an alternative example configuration of at least one embodiment, a respective detector element is already connected to a collimator element, and is aligned together with it on the support element. This alternative embodiment therefore provides quite small individual structural units or modules, which include a detector module with a collimator element arranged in front of it. The structural units are combined on the support element in order to form the bar.

An object may also be achieved according to at least one embodiment of the invention by a method for producing an X-ray detector device. Accordingly, the detector elements of a column are initially aligned sequentially, and fixed in the aligned position on a support element. The support elements are subsequently fastened on a detector support mechanism. To this end, expediently, they are mutually aligned and then fastened in the aligned position.

The advantages and example configurations mentioned in respect of the X-ray detector device may also be correspondingly applicable to example embodiments of the method.

Owing to this two-stage method, the problem of two-dimensional alignment and fastening in a flat detector having a matricial arrangement of detector elements is reduced to the problem of alignment in only one dimension. Another advantage is that the individual detector elements within a bar do not need to be positioned by special design elements. This is preferable to the conventional procedure in which each individual detector element requires accurately aligned design elements on the detector support mechanism, with the aid of which the individual detector elements are aligned and optionally fastened.

The alignment and fixing of the detector elements in order to form the bar may be carried out in a separate adjusting device. The alignment is in this case carried out, in particular, optically or mechanically on predetermined alignment points or lines. Such an adjusting device allows very accurate alignment of the individual detector elements, and can be used for producing a plurality of X-ray detectors.

Further example configurations of the method can be found in the description below.

### BRIEF DESCRIPTION OF THE DRAWINGS

An example embodiment of the invention will be explained in more detail with reference to the drawings in which, respectively in schematic and highly simplified representations:

FIG. 1 shows a flat solid-state X-ray detector, which forms a subsection of a curved lateral cylinder surface, in a detector support mechanism having a plurality of bars arranged next to one another which respectively consist of a plurality of detector modules,

FIG. 2 shows a side view of such a bar with four detector modules which are respectively provided with a collimator element,

FIG. 3 shows a plan view of a bar having three detector modules, and

FIG. 4 shows a plan view of a collimator intended for a bar according to FIG. 3.

In the figures, parts with have the same effect are provided with the same references.

### DETAILED DESCRIPTION OF THE EXAMPLE EMBODIMENTS

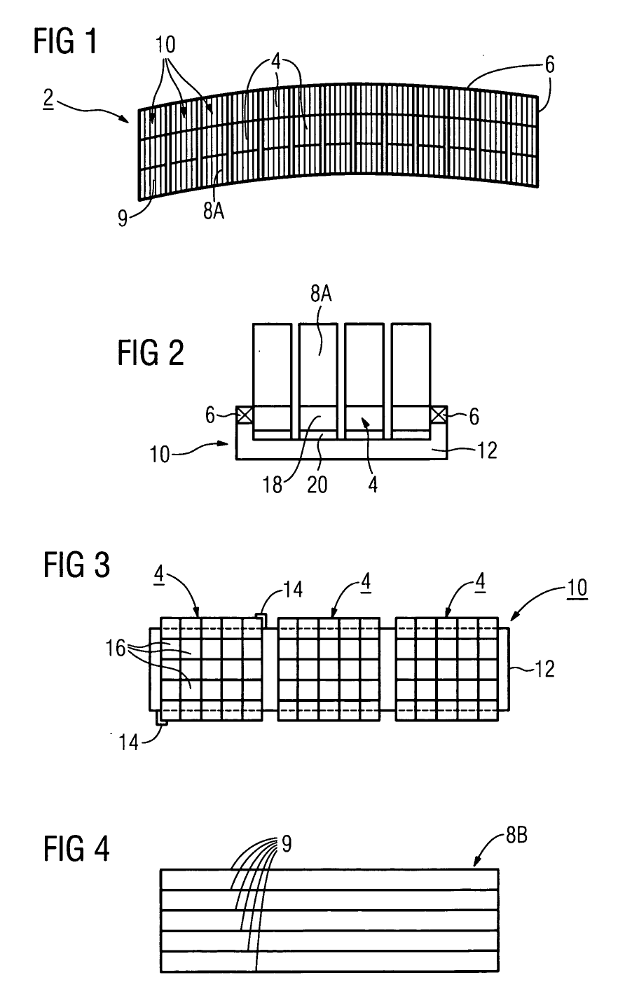

The X-ray detector 2 represented by the example embodiment in FIG. 1 is designed as a flat solid-state detector. It is formed by a multiplicity of individual matricially arranged detector elements, which are denoted as detector modules 4. The individual detector modules 4 are in this case arranged in rows and columns. The detector modules 4 are held overall in a detector support mechanism 6. In the exemplary embodiment of FIG. 1, each individual one of the detector modules 4 is assigned a respective collimator element 8A, which is connected to the respective detector module 4 and forms a structural unit with it. The collimator element 8A is arranged in front of the detector module 4 with respect to an X-ray source (not shown here).

Such an X-ray detector 2 is used in particular for medical diagnosis and examination. To this end, a patient to be examined has their body part to be exposed brought between the focus of the X-ray source and the X-ray detector 2. The rays passing through the patient are registered by the X-ray detector 2, evaluated with the aid of suitable evaluation equipment (not represented in detail here) and converted into image information. The intensity variations when radiation passes through the patient are in this case used for the evaluation. The information needed for the image generation is found from the primary rays, i.e. the undeviated X-rays. In order to generate high-quality images, it is therefore necessary to eliminate scattered rays.

To this end, the X-ray detector 2 is preceded by a collimator which is also referred to as a scattered radiation grid. In the example embodiment of FIG. 1, this collimator is composed of the multiplicity of individual collimator elements 8A. The collimator, and also the individual collimator elements 8A, have sidewalls 9 which are aligned toward the focus of the X-ray source and therefore in general almost mutually parallel. The sidewalls 9 include a material which is highly absorbent for X-rays. Scattered rays which do not arrive from the focus of the X-ray source are absorbed by these sidewalls 9.

Subregions of the surface of the X-ray detector 2, i.e. so-called dead zones, are therefore not irradiated owing to the sidewalls 9. In order to avoid image artifacts, it is necessary for the X-ray detector 2 to have insensitive regions which cover these dead zones sufficiently. The term insensitive regions is in this case intended to mean regions which do not generate a signal when X-radiation quanta strike them. It is therefore necessary for the individual detector modules 4 and the individual collimator elements 8A to be mutually aligned exactly.

In the present case, the detector modules 4 arranged in a column are furthermore combined to form a bar 10, and the individual bars 10 are aligned and fastened next to one another on the detector support mechanism 6.

FIG. 2 shows such a bar 10 in a side view. As can be seen, the individual detector modules 4 are fastened on a curved support element 12, which substantially clamps the detector modules 4. The longitudinal rails of the detector support mechanism 6 can also be seen in the side representation. Each of the individual detector modules 4 is connected to its own collimator element 8A.

The individual detector elements 4 are fastened on the support element 12, in particular by adhesive bonding. Mechanical stop or holding elements 14, with the aid of which the detector modules 4 are aligned and/or fastened, may alternatively or additionally be provided on the support element 12.

The representations according to FIGS. 2 and 3 also reveal the basic structure of the individual detector modules 4. Each of the individual detector modules 4, which are also denoted as so-called detector tiles, are formed by a matricial arrangement of individual detector pixel elements 16.

In the example embodiment, a scintillator ceramic 18 and a photodiode element 20 are provided for converting the incoming X-radiation into electrical signals. In the scintillator ceramic 18, an incoming radiation quantum is converted into photons which subsequently generate an electrical signal in the photodiode element 20. Each of the detector pixel elements 16 conventionally has a scintillator ceramic designed in the manner of a mosaic tile, and a photodiode assigned to it. Each detector pixel element 16 constructed in this way forms one image point. An individual detector pixel element 16 is conventionally rectangular and has, for example, a side length of from 1 to 1.3 mm.

A detector module 4 includes, for example, a 16×16 matrix of such detector pixel elements 16. The length of a bar 10 corresponds to the width of the X-ray detector 2. The number of individual detector elements 4 per bar 10 is correspondingly high. The individual detector modules 4 in a bar 10 are in this case respectively arranged only in one row, i.e. one-dimensionally sequenced.

In particular, the following procedure is adopted in order to construct the X-ray detector 2.

First, a plurality of detector modules 4 are aligned in a row with the aid of an adjusting and aligning device. The alignment or adjustment is carried out, for example, with optical aids in order to monitor the exact position. The detector modules 4 are, in particular, brought to the intended positions in a controlled way. After the individual detector modules 4 have been aligned, they are fastened on the support element 12 for example by adhesive bonding.

For fastening, the individual detector modules 4 are preferably clamped with the aid of the curved support element 12. The detector modules 4 conventionally lie almost directly next to one another, without a gap being formed between them. In FIG. 2, the individual detector modules 4 are represented as being spaced apart from one another merely for the sake of clarity.

In the alternative embodiment according to FIGS. 3 and 4, the collimator element 8B represented in FIG. 4 is subsequently also placed and fastened on the row of aligned detector modules 4, so that here again the bar 10 forms a structural unit with the collimator element 8B.

The bar 10 prefabricated in this way is subsequently fitted into the detector support mechanism 6, i.e. aligned and fastened on suitable fastening elements.

In order to construct the flat X-ray detector 2, it is therefore merely necessary for the individual bars 10 to be fastened and arranged next to one another in a one-dimensional direction. The original problem of aligning and fastening the individual detector modules 4 in two dimensions is therefore reduced by the two-stage process to the problem of fastening in only one direction. On the one hand, this significantly reduces the outlay for fastening in the detector support mechanism 6.

Furthermore, the prefabrication of the bars 10 with the aid of the adjusting device also readily permits accurate alignment of the individual detector modules 4 within a bar 10. This two-stage process therefore leads overall to simplified assembly and therefore to a cost saving, since elaborately configured design and holding elements are not necessary on the detector support mechanism 6. This two-stage process furthermore achieves very accurate positioning of the individual detector modules 4. Merely one-off additional costs are incurred for the adjusting device.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An X-ray detector device comprising:
a collimator; and
a multiplicity of matricially arranged detector elements, aligned in rows and columns with the aid of the collimator, the detector elements being fixed and aligned on a common support element so as to form a bar, with individual bars being fastened on a detector support mechanism.

2. The X-ray detector as claimed in claim 1, wherein the detector elements are adhesively bonded on the support element.

3. The X-ray detector as claimed in claim 1, wherein the detector elements are fastened on holding elements of the support element.

4. The X-ray detector as claimed in claim 1, wherein a respective bar is connected to a collimator element and fastened together with the collimator element on the detector support mechanism.

5. The X-ray detector as claimed in claim 1, wherein a respective detector element is connected to a collimator element and aligned together with the collimator element on the support element.

6. A method for producing an X-ray detector device having a collimator and a multiplicity of matricially arranged detector elements, the method comprising:
aligning the detector elements in a row and fixing the detector elements in the aligned position on a support element; and
subsequently fastening a plurality of support elements on a detector support mechanism.

7. The method as claimed in claim 6, wherein the fixing on the support element is carried out by at least one of adhesive bonding and with the aid of holding elements.

8. The method as claimed in claim 6, wherein a respective bar is connected to a collimator element and fastened together with the bar in the detector support mechanism.

9. The method as claimed in claim 6, wherein a respective detector element is connected to a collimator element and fixed together with the collimator element on the support element.

10. The X-ray detector as claimed in claim 2, wherein a respective bar is connected to a collimator element and fastened together with the collimator element on the detector support mechanism.

11. The X-ray detector as claimed in claim 2, wherein a respective detector element is connected to a collimator element and aligned together with the collimator element on the support element.

12. The method as claimed in claim 7, wherein a respective bar is connected to a collimator element and fastened together with the bar in the detector support mechanism.

13. The method as claimed in claim 7, wherein a respective detector element is connected to a collimator element and fixed together with the collimator element on the support element.

14. An X-ray detector device comprising:
a collimator;
a multiplicity of matricially arranged detector elements, aligned with the aid of the collimator;
a common support element to fix and align the detector elements so as to form a bar; and
a detector support mechanism to support a plurality of bars.

15. The X-ray detector as claimed in claim 14, wherein the detector elements are adhesively bonded on the support element.

16. The X-ray detector as claimed in claim 14, wherein the detector elements are fastened on holding elements of the support element.

17. The X-ray detector as claimed in claim 14, wherein a respective bar is connected to a collimator element and fastened together with the collimator element on the detector support mechanism.

18. The X-ray detector as claimed in claim 14, wherein a respective detector element is connected to a collimator element and aligned together with the collimator element on the support element.
